(19) United States
(12) Patent Application Publication
(10) Pub. No.: US 2009/0182911 A1
(43) Pub. Date: Jul. 16, 2009

(54) Memory devices and security systems and apparatus for use with such memory devices

(76) Inventors: David Henry Krasner, London (GB); Elaine Carol Kornbluth, London (GB); Jul Kornbluth, London (GB)

Correspondence Address: WILLIAM NITKIN, 1320 CENTRE STREET, SUITE 300, NEWTON, MA, 02459, US

(21) Appl. No.: 12/319,582

(22) Filed: Jan. 9, 2009

(30) Foreign Application Priority Data
Jul. 10, 2006 (GB) 0613579.2
Nov. 15, 2006 (GB) 0622794.6

(51) Int. Cl. G06F 13/38; G06F 13/14

(52) U.S. Cl. 710/63; 710/305

(57) ABSTRACT

A memory device (10) with USB connectibility and a security system (110) associated with the device (10). The memory device (10) comprises a body (12) of generally rectangular shape that is dimensioned substantially as that of a conventional credit card and is of planar form of a thickness compatible with the height of an inner space in a standard USB interface slot socket. The memory device (10) has a USB connector (15) of a generally rectangular shape and similar thickness to that of the body (12). This USB connector (15) is movable from a stored condition in which it is disposed wholly within the outline of said rectangular shape and an in-use condition in which it projects outwardly of said rectangular shape. In one embodiment the USB connector (15) is mounted slidably in a slot (16) provided in the body (12) adjacent a side (57) of the rectangular shape. In another embodiment the USB connector is (15) mounted pivotably to be accommodated in a slot (16) provided in the body (12) adjacent a side (57) of the rectangular shape when in an out-of-use or stored condition and to project from that slot (16) when in an in-use condition. The security system (110) can accommodate the memory device (10) by interengaging fittingly both with the USB connector (15) and with the body (12) of the memory device (10).

### TECHNICAL FIELD

This invention relates to memory devices and in particular to such devices with USB connectibility and of planar form, also known as ‘memory cards’. The abbreviation ‘USB’ is an acronym for Universal Serial Bus which has become the universal standard for connecting peripheral equipment to computer motherboards. Variants of the standard size USB connector, known as mini-USB, are dimensionally different but function identically. In this specification, the term “USB” refers to all dimensional variants. Furthermore, as used herein, the term “card” refers to a body of generally polygonal shape and of planar form of a thickness compatible with the height of the inner space in a standard size USB interface slot socket.

This invention also relates to security systems and apparatus, and in particular to security systems and apparatus for ensuring the safe electronic transmission and memory storage of data utilising such memory devices.

### BACKGROUND

Proposals have been made for memory devices having USB connectibility to be provided in a generally planar form, i.e. as a memory card. Examples are described in, for example, WO-2005/124932, WO-0169881, WO-03027946, WO-0148994, US-A-6813164, U.S. Pat. No. 6,900,988, U.S. Pat. No. 6,744,634, and US-A-2004/0102093. However none of such devices provides a wholly satisfactory combination of compactness, neat appearance, ease of use and convenient snag-free storage, e.g. in a pocket, wallet, purse or handbag.

Typically, such a USB connectible portable memory device can be used as a means to store, retrieve and transfer information or data from one computer to another. For example, in one mode of use, the portable memory device is temporarily connected to the standard USB port of a computer which regards it as a removable disk drive, data from the computer's hard disk is then downloaded onto the memory device, the memory device is then disconnected from the computer's standard USB port and removed so as to provide a ‘backup’ store of the downloaded data. The stored data can be subsequently restored to the same computer or loaded into another computer, by connecting the memory device to the standard USB port of that computer or the other computer, which can then upload the stored data from the temporarily connected memory device.

Whilst such memory cards, i.e. memory devices with USB connectibility and of planar form, can be used with a conventional, computer-mounted, USB connector, certain special circumstances or requirements can arise where the information or data contained in, or to be transferred to or from, the memory device is of a sensitive or private nature such that access thereto should be restricted and safeguarded (rather than being easily available through any conventional USB port). An example of such a requirement is to protect intellectual property and provide software copy protection. It is therefore considered desirable to provide a security system and apparatus that permits access to data in a restricted manner.

### SUMMARY OF THE INVENTION

According to a first aspect of the present invention there is provided a memory device with USB connectibility wherein said memory device comprises a card with a body as hereinbefore defined with a USB connector of a generally rectangular shape and similar thickness to that of the body, characterised in that said USB connector is movable from a stored condition in which it is disposed wholly within the outline of the card's polygonal shape and an in-use condition in which it projects outwardly of said polygonal shape.

The USB connector may be mounted slidably in the plane of the device between said stored and said in-use conditions. Preferably however, the USB connector is mounted pivotably between said stored and said in-use conditions and in each condition is substantially in the plane of the memory device.

Conveniently, the body of the memory device houses one or more electrical components that are connected by wires to elongate contact strips on one surface of the USB connector, said wires passing through the pivot axis of the USB connector.

Preferably means are provided to restrain pivotal movement of the USB connector, e.g. so as not to exceed 360°, thereby to avoid over-twisting of the connecting wires that extend through the pivot.

Advantageously the card is provided with a slot which accommodates the USB connector when the latter is in its stored condition, the base edge of the slot has a stepped configuration and the leading edge of the USB connector has a correspondingly stepped configuration, the pivot axis for the USB connector being located such that, when the USB connector is pivoted in one direction from its in-use condition to its stored condition, the two said stepped configurations can enter into fitting interengagement with one another so that the USB connector can lie flush in the plane of the memory device (and wholly within the outline of said polygonal shape), but when the USB connector is pivoted in the opposite direction from its in-use condition, the projecting tip portions of the two said stepped configurations approach mutual surfacial abutment to prevent interengagement of the stepped configurations. This serves to restrain pivotal movement to less than a full 360° and avoids over-twisting of the connecting wires that extending through the pivot

According to a second aspect of this invention there is provided a security system comprising, in use:
a memory device with USB connectibility, according to said first aspect of this invention, said USB connector occupying a predetermined position relative to two mutually spaced outermost edges of the polygon having a predetermined distance between them,
and a read/write unit to read data from and/or to write data to the memory device, said unit having
(a) an entrance slot to receive at least partially the body of said card when the card is in use and inserted into said slot with the USB connector leading,
(b) mutually spaced engagement means—having a like predetermined distance between them—within the unit for engagement of the said two mutually spaced outermost edges of the polygon,
(c) a USB interface slot socket to receive and be couplingly connected to the projecting USB connector of a said inserted body, said socket occupying a position relative to said mutually spaced engagement means in correspondence with the said predetermined position of the USB connector.

The term “polygon” as used herein is not intended to exclude shapes having linear edges that are curved at their ends to provide for the generally polygonal shape to have rounded corners.

Preferably the generally polygonal shape is a generally rectangular shape.

It will be appreciated that by providing the mutually spaced engagement means with a predetermined distance between them which is substantially the same as (i.e. commensurate with) the predetermined distance between said two mutually spaced outermost edges of the polygon, an improper, oversize card—that has a greater distance between said two outermost edges—cannot be inserted into or through the entrance slot of the read/write unit, i.e. such insertion is prevented.

Optionally, and for use with a plurality of memory devices having different predetermined positions for their respective projecting USB connectors, the read/write unit may include a plurality of USB interface slot sockets occupying different positions relative to the said mutually spaced engagement means, each such socket position corresponding respectively with a different one of predetermined USB connector positions of the plurality of memory devices.

Preferably the USB connector, or one of the USB connectors, has both its side edges spaced from the line of each of said two mutually spaced edges.

The mutually spaced engagement means may be provided by rollers, slides or other guidance members to guide the body of the memory device along the path of its insertion into the read/write unit.

Alternatively, and preferably, the mutually spaced engagement means are provided by the opposed, narrow, side walls of an open-mouthed, box-like receptacle having its mouth defined by said entrance slot, a base wall of said receptacle serving to mount said USB interface slot socket and to provide an end stop for said one edge of the polygon when the memory device's body is inserted.

The effect of such mounting is to create the equivalent of a stepped recess with a wider portion adjacent the entrance slot and, opposite the entrance slot, with a narrower portion defined by the USB interface slot socket, the predetermined position of which corresponding with some precision to the predetermined position of the USB connector. Accordingly a good mating physical fit, of a plug-and-socket kind, is provided for the specific memory device employed, and the said read/write unit and memory device are thereby substantially dedicated to one another.

Advantageously the read/write unit of said security system is for use by a system administrator and the said memory device therefor is the administrator memory device, said security system comprising another, like, read/write unit, the two units being in use connected to one another with said other read/write unit being for use by an end user or data recipient and to receive another, like, memory device personal to that end user.

Preferably the security system is programmed to permit selected data from an updatable memory store to be transferred to the personal memory device under the control of the administrator's read/write unit.

Advantageously the administrator's read/write unit is programmed to manipulate and/or translate the selected data it receives into a uniform format and transfer it in that format
(a) to the end user read/write unit so as to be written to the personal memory device therein, and
(b) to the administrator read/write unit so as to be written to the administrator's memory device therein to be added to previously written and transferred selected data pertaining to previous end users of the system.

Preferably, before transferring said selected data (which is preferably specific to the end user), the program controlling the administrator read/write unit generates a master code that is transferred to the end user read/write unit so as to be written to the personal memory device therein in combination with a personal code generated by the end user read/write unit.

According to a third aspect of this invention there is provided security apparatus comprising a read/write unit having features suiting it for use in a security system according to said second aspect of the invention.

### BRIEF DESCRIPTION OF THE DRAWINGS

By way of example embodiments of this invention will now be described with reference to the accompanying drawings of which:

FIG. 1 is an exploded perspective view of a memory device according to a first embodiment of the present invention,

FIG. 1a is an enlarged view of part of FIG. 1,

FIG. 2 is a perspective underneath view of parts of a modified form of memory device in partially assembled state,

FIG. 3a is a schematic cross-sectional view illustrating permitted pivotal movement of the USB connector of the illustrated memory device into its stored condition,

FIG. 3b is a similar view to that of FIG. 3a but illustrating non-permitted pivotal movement of the USB connector of the illustrated memory device into its stored condition,

FIG. 4 is a plan view of a memory device according to the present invention with the USB connector thereof in its stored condition,

FIG. 5 is a plan view of a memory device according to the present invention with the USB connector thereof in its in-use condition,

FIG. 6 is a front perspective view of a first read/write unit of an embodiment for use with a memory device according to this invention,

FIG. 7 is a rear perspective view of the read/write unit of FIG. 6,

FIG. 8 is a front perspective view of a second read/write unit of an embodiment for use with a memory device according to this invention,

FIG. 9 is a rear perspective view of the read/write unit of FIG. 8, and

FIG. 10 is a schematic plan view of the units of FIGS. 6 to 9 and illustrating electrical connections between them.

### DETAILED DESCRIPTION OF EXAMPLE(S) OF THE INVENTION

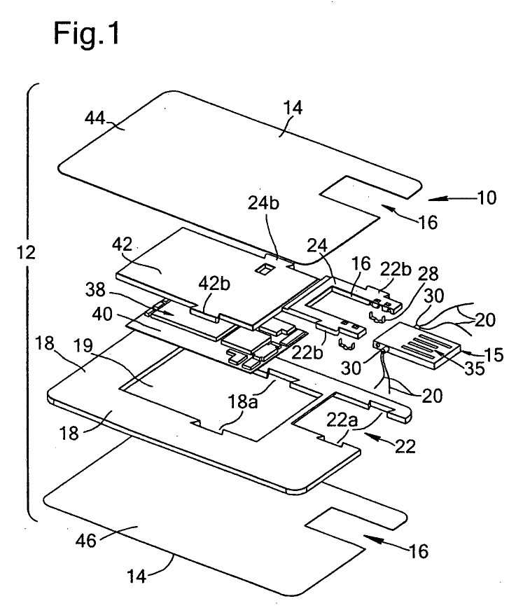

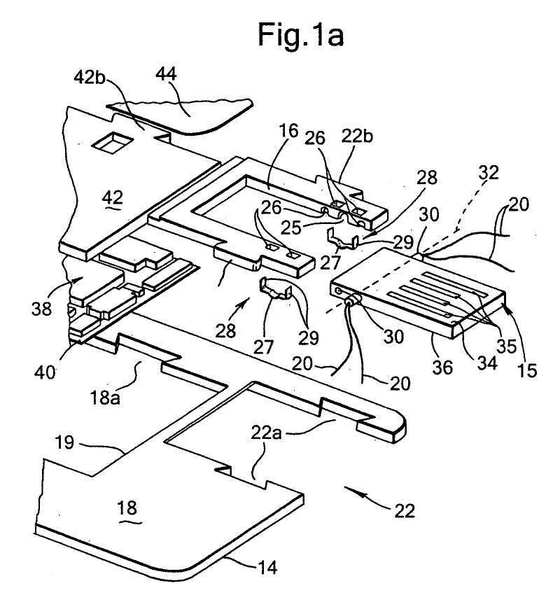

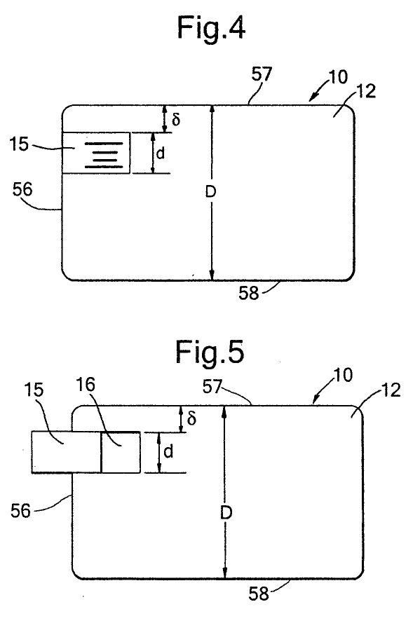

The memory device 10 (best shown in FIGS. 1 to 5) is a so-called memory card which comprises a body 12 of planar form having the generally polygonal outline shape of a rectangle provided with rounded (or radiussed) corners and of a correspondingly similar size in plan view to that of a conventional ATM or credit card, i.e. about 8.5 cm by 5.4 cm. However the body 12 is slightly thicker than such a conventional card and has a thickness compatible with the height of the inner space of a standard USB interface slot socket. The memory device 10 also has a USB connector 15 of generally rectangular shape and with a similar thickness to that of the body 12, i.e. between 1 mm and 2.7 mm for a standard size USB connector 15 or between 0.3 mm and 1.1 mm for a mini-USB connector. The USB connector 15 is movable from a stored condition in which it is disposed wholly within the outline 14 of said generally rectangular-shaped body 12 (see FIG. 4) and an in use condition in which it projects outwardly of the generally rectangular outline 14 (see FIG. 5).

To provide for this movement, the USB connector 15 of the illustrated embodiment is mounted pivotably within a slot 16 cut or otherwise provided within the outline 14 of said generally rectangular-shaped body 12.

The body 12 of the memory card 10 comprises a rigid outline frame 18 of PVC defining a generally rectangular enclosed space 19 provided in its inner outline with two oppositely located dovetail-shaped cut-outs 18a. Adjacent one shorter edge, the frame 18 is wider and provided with an open-ended slot 22 of generally rectangular shape provided with two oppositely located dovetail-shaped cut-outs 22a. A generally U-shaped rigid sub-frame 24 with laterally opposite dovetail-shaped projections 22b is fitted within cut-out 22, the dovetail cutouts and projections 22a, 22b interfitting with one another. The U-shaped sub-frame 24 is provided in each limb with a part-circular recess 25 located between a pair of adjacent through-holes 26, the axes of the two part-circular recesses 25 being coaxial with one another and parallel to the adjacent shorter edge of the memory card 10. The USB connector 15 is provided with a pair of coaxial, hollow stub axles or trunnions 30 opposite one another that are rotatably accommodated within the recesses 25. Staples 28 of strip-like form, each having a part-circular concave formation 27 in its bight wall and a pair of deformable limbs 29, have their limbs 29 inserted through the holes 26 and bent over to retain the staples 28 in position with their concave formations 27 engaging the stub axles or trunnions 30. The staples 28 thus serve to fasten the USB connector to the sub-frame 24 but do so in a manner permitting the USB connector 15 to rotate about the common axis 32 of the stub axles or trunnions 30, the part-circular concave formation 27 of the staples' bight walls aiding this rotatable function.

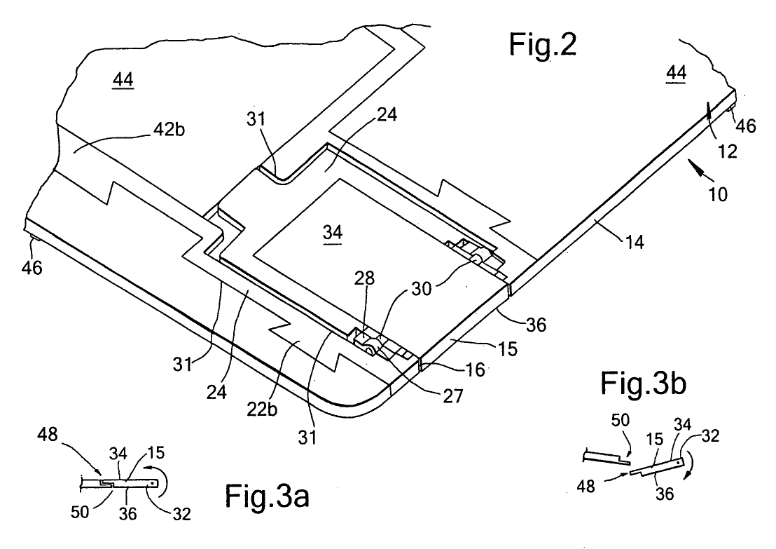

The USB connector 15 is provided with four elongate contact strips 35 on one surface 34 of the USB connector 15 (not shown in FIG. 2), the opposite surface 36 being without such contact strips. The four elongate contact strips 35 are for use as conventional electrical contacts V_{BUS}, D−, D+ and GND for respectively the positive voltage rail, positive and negative data lines, and ground. Four wires 20 extend internally of the USB connector 15, and pass through one or each of the hollow stub axles or trunnions 30 and from there pass into and along channels 31 (FIG. 2) in the underside of the sub-frame 24. These channels 31 lead from the recesses 25 to the distal edge of the sub-frame and guide the wires 20 for connection to one or more electrical components 38 incorporated on a printed circuit board (PCB) 40. The wires 20 can be retained in the channels 31 by a waterproofing glue.

The PCB 40 is located within the generally rectangular enclosed space 19 provided by frame 18. It is retained firmly within space 19 by a generally rectangular support plate 42 of plastics material that is provided along its longer sides with two oppositely located dovetail-shaped projections 42b, these dovetail-shaped projections 42b fitting into the dovetail-shaped cut-outs 18a of the rigid frame 18.

The body 12 further comprises top and bottom cover sheets 44, 46 of PVC which may be marked with advertising or other indicia. Because the USB connector 15 of the memory card 10 has its terminals or contact strips 35 visible to the user, the user can readily identify which way up the memory card 10 is to be orientated to effect connection between the USB connector 15 and the computer motherboard or peripheral equipment to which it is to be connected. Accordingly the markings on the cover sheets 44, 46 can be the same, i.e. they need not differ so as to indicate to the user which is the top and which is the bottom of the memory card 10.

The memory device 10 is provided with means, e.g. a detent 45, to retain the USB connector 15 coplanar with the body 12 when the USB connector is pivoted to its in-use condition in which it lies at 180° to the plane of the body 12.

Additionally, the memory device 10 may be provided with means to restrain pivotal movement of the USB connector 15, e.g. so as not to exceed 360°, thereby to avoid over-twisting of the connecting wires 20 that extend through the hollow stub axles 30. As illustrated in FIGS. 3a and 3b, such pivotal movement restraining means may be obtained by
(a) providing the leading edge of the USB connector 15 with a stepped configuration 48,
(b) providing the base edge of the slot 16 (that accommodates the USB connector 15 when the latter is in its stored condition) with a correspondingly stepped configuration 50, and
(c) providing for the pivot axis 32 for the USB connector to be located such that, when the USB connector 15 is pivoted in one direction from its in-use condition to its stored condition, the two said stepped configurations 48,50 can enter into fitting interengagement with one another (FIG. 3a) so that the USB connector 15 can lie flush in the plane of the memory device 12 (and wholly within the outline 14 of said polygonal shape), but when the USB connector 15 is pivoted in the opposite direction from its in-use condition, the projecting tip portions of the two said stepped configurations 48,50 approach towards mutual surfacial abutment (FIG. 3b) to prevent interengagement of the stepped configurations 48,50.

These features serve to restrain pivotal movement of the USB connector 15 to less than a full 360° and thereby prevent over-twisting of the connecting wires 20 that extend through the pivot stub axles 30.

It will be appreciated that both in said stored condition and in said in-use condition, the USB connector 15 can lie substantially in the plane of the body 12 of the memory device 10.

In a modified arrangement to that illustrated in FIGS. 1 and 1a, and as suggested by FIG. 2, the support plate 42 and the U-shaped rigid sub-frame 24 are provided as an integral unit with one another rather than separate units as described above.

In an alternative embodiment of the present invention, instead of being mounted pivotably, the USB connector 15 is mounted slidably in the slot 16 so as be movable in the plane of the body 12 of the memory device 10 between said stored and said in-use conditions. Here too, the USB connector 15 lies substantially in the plane of the body 12 of the memory device 10 both in said stored condition and in said in-use condition.

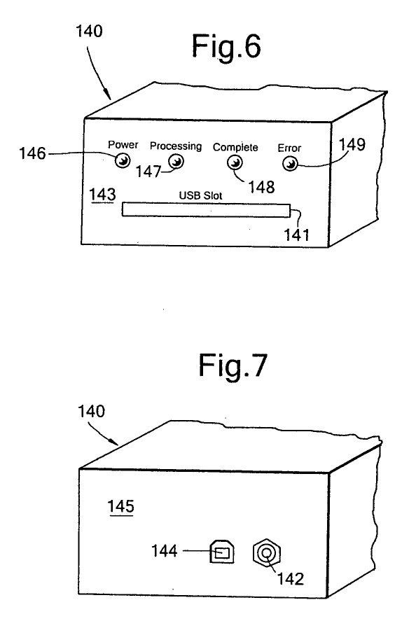

The memory card 10 described above may be used as a straightforward ‘flash card’ or conventional memory device. However such a memory card 10 may have a particularly useful function in conjunction with the security system 110 described below with reference to FIGS. 6 to 10.

The illustrated security system 110 (FIGS. 6 to 10) is primarily (but not exclusively) for use in a medical facility, e.g. in the surgery or consulting rooms of a doctor, physician, surgeon, dentist or veterinary surgeon, in a clinic or in a hospital. Its purpose is to provide for the secure downloading, onto a portable memory device such as the card 10 of FIGS. 1 to 5, of a patient's personal medical records. These records are obtained from a store of many such patient records held in a main computer of the medical facility. The illustrated security system 110 is a “stand alone” installation in that it does not alter or interfere with the data stored in the main computer of the medical facility but simply reads any one of specific selections of that data that pertain, on a case-by-case basis, to a corresponding one, pre-authenticated patient (or other entitled recipient), and then copies or transfers that data selection to the portable memory device 10 that is personal to that one patient. Optionally, and prior to transfer, the data is manipulated and/or translated into a common, user readable format that is independent of the format of the originating data stored in the main computer.

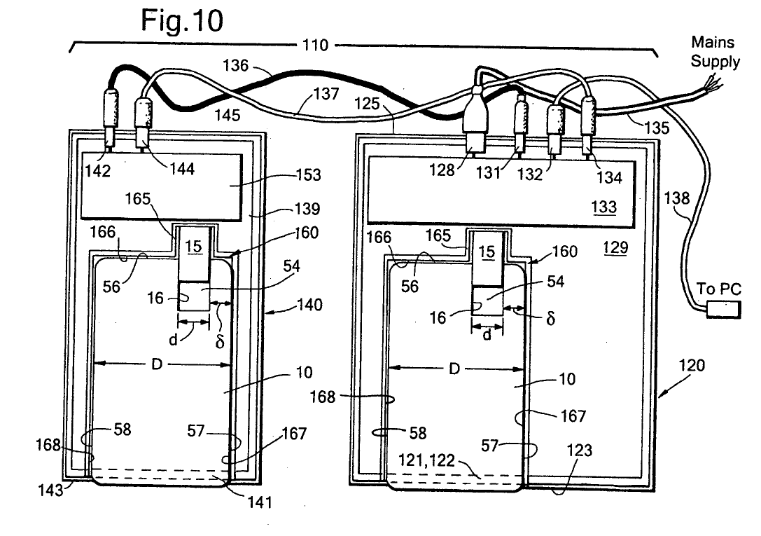

The preferred illustrated system 110 (FIG. 10) comprises two read/write units 120,140 that are each co-operative, for reading and writing, with a memory device 10 (FIGS. 1 to 5) that is a flash memory card.

As indicated above, the memory device or flash card 10 comprises a body 12 having a substantially planar form and having the general shape of a rectangular polygon of a size in plan view corresponding to that of a conventional credit card. The body 12 has a uniform thickness which is commensurate with the internal height between two opposed wider faces of a standard USB interface slot socket, e.g. in this embodiment a height between 1 mm and 2.7 mm, and such that part of the body 12 can be slidingly inserted into such a USB interface slot socket. The body 12 has a USB connector 15 of the same thickness as the remainder of body 12. This USB connector 15, at least in use, projects from one shorter edge 56 of the rectangular polygon and occupies a predetermined position relative to the two mutually spaced, outermost, longer edges 57,58 of the rectangular polygon. The predetermined distance D between these longer edges 57,58 is defined by the width of the card-like body 12, e.g. in this embodiment a width of 5.4 cm. As shown best in FIGS. 4 and 5, the USB connector 15 itself has a width d and is located a distance δ (delta) from the nearest edge 57 of the flash card 10.

In this embodiment the USB connector 15 is movable, preferably pivotably, into and out of a slot 16 provided in the form of a cut-out 54 (of the same width d) in the shorter edge 56 of the body 12 of the flash card memory device 10.

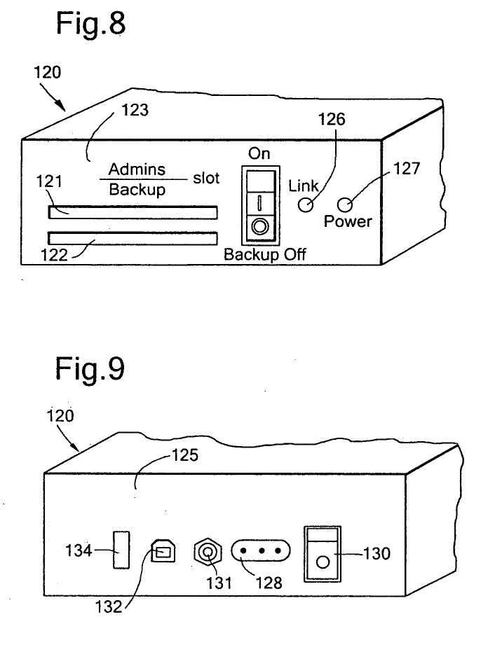

The read/write unit 120 is for use by a system administrator. It comprises a housing of generally parallepiped form and has a front face 123 (FIG. 8) with two slot-like openings 121,122 therein (see also FIG. 10). An ON/OFF switch 124 is mounted on the front face 123 which is also provided with two LED visual indicators 126,127 labelled “LINK” and “POWER”. The rear face 125 of the unit 120 (FIG. 9), and/or a circuit board 129 (FIG. 10) mounted within the housing of unit 120, serves to mount a mains power input connector 128, a mains power switch 130, a 5 volt DC output connector 131—deriving its power from a transformer/rectifier arrangement (not shown) located within unit 120—a mini-USB connector 132, and a full-size USB connector 134. The circuit board 129 serves to mount appropriate electronic components and circuitry designated 133 in FIG. 10.

The read/write unit 140 also comprises a housing of generally parallepiped form with a front face 143 (FIG. 6) provided with just a single slot-like opening 141 therein (see also FIG. 10). The front face 143 is provided with four LED visual indicators 46-49 labelled “POWER”, “PROCESSING”, “COMPLETE” and “ERROR”. The rear face 145 of unit 140 (FIG. 7), and/or a circuit board 139 (FIG. 10) mounted within the housing of unit 140, serves to mount a 5 volt DC input connector 142 and a mini-USB connector 144. The circuit board 139 serves to mount appropriate electronic components and circuitry designated 153 in FIG. 10.

Each unit 120,140 also houses a flat, open-mouthed, box-like receptacle 160 having its mouth defined by or aligned with a respective entrance slot 121,122 and 141. The base wall 166 of each receptacle 160 serves to mount a respective USB interface slot socket 165 and provides an end stop for the leading shorter edge 56 of the rectangular memory card 12 when it is inserted into the entrance slot 121,122 or 141 (as the case may be). The side walls 167,168 of each box-like receptacle 160 are spaced apart by a distance D and thus these side walls 167, 168 serve as guidance members to guide the memory card 12 slidingly along the path of its insertion into the read/write unit 120,140. The USB interface slot socket 165 is to receive and be couplingly connected to the projecting USB connector 15 of the particular inserted card 10 and, for this, the socket 165 occupies a position relative to the mutually spaced engagement means provided by walls 167,168 that corresponds with the predetermined position of the USB connector 15 on the card's body 12. In other words, and as shown schematically in FIG. 10, the socket 165 is spaced a similar distance δ (delta) from receptacle side wall 167 as the distance δ (delta) that connector 15 is distanced from the longer side edge 57 of the rectangular body 12.

The effect of such mounting of the USB interface slot socket 165 is to provide the interior of each receptacle 160 as substantially equivalent to a stepped recess with a wider portion adjacent the entrance slot 121,122 or 141, and, opposite that entrance slot, with a narrower portion defined by the USB interface slot socket 165 and having a predetermined position corresponding with some precision to the predetermined position of the USB connector 15. Accordingly a good mating physical fit is provided for the specific memory device 10 employed, and the said read/write unit 120,140 and memory device 10 are thereby substantially dedicated to one another.

Assembly of the system 110 and interconnection of units 120 and 140 are best illustrated in FIG. 10. This shows, somewhat schematically, a mains power cable 135 connected from a mains source (not shown) to input connector 128, a low-voltage cable 136 interconnecting output connector 131 of unit 120 to the input connector 142 of unit 140, a USB cable 137 interconnecting connector 134 of unit 120 with the connector 144 of unit 140, and another USB cable 138 connecting connector 132 of unit 120 to a USB port of the main computer (not shown).

It will be appreciated that almost every doctor's surgery or other medical facility (in the UK and other countries) operates a medical information system (MIS) to manage its patient medical records, and that, with the above-described and illustrated system 110, such an MIS is capable of exporting an individual patient's (or user's) medical record—upon the user's request—to the user's personal and portable memory device or flash card 10. This will allow the user to access/read the data as necessary at various different locations—including on his/her personal computer, other computers he/she may use for his/her needs, or even indeed a computer system at another doctor, specialist, physician or surgeon—merely by connecting that personal flash card 10 into the standard USB socket of that computer. The “location” can be either secure or insecure, such as an Internet Café, Airport, or the like. Be the location secure or insecure, the information on the personal memory device or flash card 10 must be “read only”, i.e. be only viewable and non-modifiable; it must not be susceptible to being cached or passed to some other computer programs.

Furthermore, for “writing” the data to the personal memory device or flash card 10 it is of prime importance that the user's authenticity be verified (e.g. by presentation of a passport or other photographic ID) when he/she comes to the surgery to obtain a data download onto his/her personal card. Moreover, after successful verification and during the medical data export in a secure and authorised manner (e.g. by the doctor or an authorised member of the surgery staff), infection of the surgery's computer with viruses and malware from the user's personal card 10 must be prevented.

To achieve these criteria, the system 110 and its operation can be considered as composed of the following 3 different parts or stages:

### 1. The “Card Issuing Stage”,

### 2. The “Surgery Stage” and

### 3. The “Individual User Stage”.

Each of these 3 stages involves data storage on one or more different removable media devices or flash cards 10, and each such stage includes storage onto the respective memory device 10 of some software components and a special protected area (e.g. a file) which is encrypted using a combination encryption technique.

### Stage 1—The “Card Issuing Stage”

The office responsible for issuing the cards (which may be the doctor's surgery or, preferably, the main service provider supplying the flash cards 10) creates both a surgery card 10 for use in unit 120 and an end user card 10 for use in unit 140. Each doctor's surgery has its own unique RSA 4096 Digital Signature and this is incorporated into each of the user cards 10 of end users belonging to, i.e. patients of, that particular surgery. This ensures that any end-user card 10 will be operational (i.e. susceptible of being written to) only within that doctor's surgery—although, as indicated above, that end-user card 10 can be read from at any other surgery or by the patient himself/herself.

Usually the (or each) office responsible for the card issuing stage produces just one “Office” card and this holds a list of surgeries and their associated unique RSA 4096 Digital Signatures. The “Office” software has the capability to activate an empty card for the office, for a surgery and for the end user. This “Office” software asks for an encryption pass-phrase to be provided, and from this it generates a code in the form of an ‘AES 256 key’ for the card being encrypted. The office card 10 cannot be used in the system 110 before it is authenticated and authorised, to which end an Office employee enters (into the PC running the software) the pre-selected encryption pass-phrase and this grants authorization or authentication to the office card 10. Once authorized or authenticated, the Office employee can perform one or more of the following:
Change his/her current pass-phrase.
Create a Surgery Card and one or more User cards
Manage records pertaining to card usage by surgeries and users.
Delete a surgery or a user.

### Stage 2/3—The “Surgery Stage”/“Individual User Stage”

The Surgery Stage and the Individual User Stage are provided in the surgery premises by the two terminals or read/write units 120,140. As indicated above, the surgery terminal 120 and the user terminal 140 are interconnected to each other, and the surgery terminal 120 is further connected (by cable 138) to the computer on which the Medical Information System (MIS) is installed. Under the software installed on that computer, the surgery terminal 120 acts and controls the activity of the end user terminal 140, but does not permit ‘back interference’ from terminal 120 (or 140) to the MIS. System 110 thus functions as a ‘stand alone’ system. The surgery terminal 120 is activated by inserting the surgery card 10 and entering the correct pass-phrase for that surgery. Until the correct surgery pass-phrase is entered both the surgery terminal 120 and the user terminal 140 remain inactive. Once the correct surgery pass-phrase has been entered, both the surgery terminal 120 and the end user terminal 140 are activated.

When the user inserts his/her flash memory card 10 into the user terminal 140, the surgery software application produces an RSA Handshake Test upon the user card 10. If the card signifies the user does not belong to (i.e. is not a patient of) that particular surgery, the surgery terminal 120 de-activates the user terminal 140.

To provide for this, the surgery card 10 initially received from Stage 1, i.e. from the card issuing office, has an RSA 4096 (handshake) public key part recorded on it by that office for user card identification when the user comes to the surgery. The software application running on the surgery computer renders a number of operations available for the surgery with the surgery card 10, including:
Change of the surgery card encryption pass-phrase,
Register a new User card into the surgery card database issued by the Office and signed with the handshake key,
Perform an MD5 checksum to check if data was tampered with by the user since his/her previous update,
Upload a User's medical data from the main computer's MIS to his/her card, and Browse/Manage an associated user database.

To be initially issued with an end user flash memory card 10 from the Card Issuance Office of Stage 1, i.e. the main service provider (which is generally constituted by the doctor's surgery or, preferably, the supplier of the flash cards 10), the prospective user must first subscribe to the service by completing a form with his/her details doing this either at the surgery or from the website of the main service provider. A clerk or other employee of the main service provider registers the user with his/her details in the office registry and initializes/activates an end user card in tandem with the office software and the service provider's main office (backup) card 10.

Once the user receives his/her personal card 10, he/she will have to choose a pass-phrase to activate the card. A Dynamic AES 256 volatile key and an RSA 4096 public and private key pair are generated based on this chosen pass-phrase. Both the public and private keys are stored on the end user's card 10 until he/she proceeds to register at the doctor's surgery.

For such registration, the first time the user goes to the surgery (s) he needs to present a personal identification document, e.g. Passport or Driving Licence. After the doctor's receptionist has confirmed the user's identity, the user is asked to insert his/her card 10 into the user terminal 140. An RSA 4096 key handshake attempt is effected between the surgery card 10 in terminal 120 and the end user card 10 in terminal 140 to check if the user card 10 is genuine and if its owner is a patient of that particular surgery. At this point the user's personal details and the RSA 4096 public key (which was generated based on his pass-phrase) is exported to the surgery card 10 in terminal 120. The RSA 4096 public key is then erased from (or ceases to exist on) the user card 10 in terminal 140 until the user decides to change his/her pass-phrase.

Prior to export of a user's personal Medical Data to that user's flash memory card 10 in terminal 140, the RSA Handshake test first checks to see if this particular card 10 belongs to a patient of this surgery. Once the user's card 10 passes the RSA Handshake test, the surgery program will generate a one-time random AES encryption key and encrypt the medical data of that particular user with it. The AES key set itself is encrypted by the user's public key part of the RSA 4096 bit key stored in that user's record on the master card 10 in the read/write terminal 120. It then applies an MD5 algorithm on the encrypted data, and stores the digest on the master card 10 in the read/write terminal 120.

Finally the program stores the encrypted medical data and the encrypted AES key set to the user card 10 in the read/write terminal 140. The AES key set can now be decrypted by the private part of the RSA 4096 key which is stored on the user card 10 and is protected by the encryption pass-phrase. This ensures that only the genuine end user who possesses the card 10 and knows the correct pass-phrase can access the medical data recorded thereon.

The detail of this procedure, whereby the user-specific personal medical data is exported to the user's card 10, is as follows. When the user comes to the surgery to download his/her medical data, he/she inserts his/her card 10 into the terminal 140. The RSA Handshake test checks to see if this particular card belongs to this surgery. Once the RSA Handshake is successfully passed, the MIS will export the patient's medical data to a program “clip-board” in an unstructured text format. The surgery program then parses that text in to an XML format and stores it in binary databases, generates a one-time random AES key, encrypts the databases using this AES key, then utilises the user's private key stored on the surgery card 10 in terminal 120 to encrypt it (further), applies the MD5 algorithm on the encrypted data, and then stores the digest on the surgery card 10 in terminal 120 for time-stamp purposes. Finally the program scrambles the encrypted medical data and stores it to the end-user card 10 in terminal 140. The AES key set can now be decrypted by the private part of the RSA 4096 key which is stored on the user's card 10 and which is protected by the encryption pass-phrase. This ensures that only the genuine user who possesses the user card and knows the correct pass-phrase can access the specific medical data personal to him/her and stored on that user card 10.

It will be appreciated that data security is maximised in the above-described embodiment of this invention separately and jointly by the software program and by the physical interfitting of the card 10 and its associated terminal 120,140. This physical interfitting includes:
the guiding/sliding between the card edges 57,58 and the correspondingly distanced receptacle walls 167,168 providing a mating fit with one another,
the guiding/sliding between the card's USB connector tab 15 and the USB socket 165 which are a close and mating fit with one another, and additionally
the resilient gripping interconnection of the card's USB connector tab 15 and the USB socket 165 due to the standard resilient contacts provided in the socket 165.

From the foregoing it will be appreciated that secure computer downloads can be readily made to a portable, personal memory device provided by the USB flash memory card 10. For this, two linked ‘card reader’ units 120,140 are provided capable of writing to and reading from two rewritable (different forms of) data storage cards 10 provided with USB connectors, 15 as described above with reference to FIGS. 1 to 5. (Such cards 10 are illustrated in Community Registered Designs Nos. 551122-0001 to -0004). One card reader, the master unit 120, controls download from the main system computer to the other card reader, the end user unit 140, after supplying a ‘master’ key code (somewhat like a public key code) to the end user data storage card 10 in the end user unit 140. The latter uses that key code to compose a composite ‘master+private’ key code which is supplied to the data storage card 10 in the end user unit 140. Once ‘security enabled’ by receipt and recordal of the ‘master+private’ key code, the operator can switch from ‘computer isolated’ mode to ‘download’ mode to permit download to the end user card 10 of specific pre-selected data from the MIS (i.e. data specific to that end user) and to the master card which holds data of all users—or at least those to whom an end user download has been made.

In an optional modification, in addition to the read/write unit 120 and/or 140 being for use with the memory device provided by the flash memory card 10 of FIGS. 1 to 5, the unit 120 and/or 140 may be capable of reading from and writing to a memory device that is a flash memory card of different shape and/or of different construction. Such an alternative card may be one of the other shapes represented in Community Registered Designs Nos. 551122-0001 to -0004, or it may conceivable be a card such as that illustrated in WO-2005/124932.

Where either or both of the terminals 120,140 is for use with a plurality of memory devices having different predetermined positions for their respective projecting USB connectors 15, the or each read/write unit 120,140 will need to include a plurality of USB interface slot sockets 165 occupying different positions (i.e. different values of δ) relative to the mutually spaced, card-guiding, engagement means provided by the side walls 167,168 of the open-mouthed, box-like receptacle 160, and with each such socket position corresponding respectively to a different one of the predetermined USB connector positions (i.e. different values of δ) of the plurality of memory devices 10.

It will be appreciated from the foregoing that the software governing operation of the system 110 of this embodiment provides a program to manipulate and/or translate the selected data to be received by unit 120 into a uniform format, e.g. the format of a conventional text file or of an XML format, and transfer it in that format

(a) to the end user read/write unit 140 so as to be written to the personal memory device 10 therein and be thereby readable as conventional text by any home computer, and
(b) to the administrator read/write unit 120 so as to be written to the administrator's memory device 10 therein and such as to be added to previously written and transferred selected data pertaining to previous end users of the system (optionally also so as to be thereby readable as conventional text by any home computer).

It will also be appreciated that other modifications and embodiments of the invention, which will be readily apparent to those skilled in this art, are to be deemed within the ambit and scope of the invention, and further that the particular embodiment(s) hereinbefore described may be varied in construction and detail, e.g. interchanging (where appropriate or desired) different features of each, without departing from the scope of the patent monopoly hereby claimed.

We claim:

1. A memory device with USB connectibility wherein said memory device comprises a body of generally polygonal shape and of planar form of a thickness compatible with the height of an inner space in a standard USB interface slot socket, wherein said memory device has a USB connector of a generally rectangular shape and similar thickness to that of the body, said USB connector is mounted pivotally about an axis in the plane of the body such as to be movable from a stored condition in which it is disposed wholly within the outline of said polygonal shape and in the plane of the body and an in-use condition in which it projects outwardly of said polygonal shape, characterised in that the body of the memory device houses one or more electrical components that are connected by wires to elongate contact strips on one surface of the USB connector, said wires passing through the pivot axis of the USB connector.

2. A memory device according to claim 1, wherein means are provided to restrain pivotal movement of the USB connector thereby to avoid over-twisting of the connecting wires that extend through the pivot, said restraining means being characterised by providing the leading edge of the USB connector with a stepped configuration and providing the base edge of a slot, that accommodates the USB connector when the latter is in its stored condition, with a correspondingly stepped configuration, the pivot axis for the USB connector being located such that, when the USB connector is pivoted in one direction from its in-use condition to its stored condition, the two said stepped configurations can enter into fitting interengagement with one another so that the USB connector can lie flush in the plane of the memory device, and wholly within the outline of said polygonal shape, but when the USB connector is pivoted in the opposite direction from its in-use condition, the projecting tip portions of the two said stepped configurations approach mutual surfacial abutment to prevent interengagement of the stepped configurations.

3. A memory device according to claim 2, wherein said means to restrain pivotal movement of the USB connector are such as to prevent rotation exceeding 360 degrees.

4. A memory device according to any preceding claim wherein said body of planar form has its major face of generally rectangular shape and of dimensions corresponding substantially to those of a conventional credit card.

5. A memory device according to claim 1 in use as part of a security system, the USB connector of the memory device in use projecting from one edge of the polygon and occupying a predetermined position relative to two mutually spaced outermost edges of the polygon having a predetermined distance between them, said memory device being located in a read/write unit to read data from and/or to write data to the memory device, said read/write unit having
(a) an entrance slot to receive at least partially the body inserted into said slot with the USB connector leading,
(b) mutually spaced engagement means, having a like predetermined distance between them, within the unit for engagement of the said two mutually spaced outermost edges of the polygon, and
(c) a USB interface slot socket to receive and be couplingly connected to the projecting USB connector of said inserted body, said socket occupying a position relative to said mutually spaced engagement means in correspondence with said predetermined position of the USB connector.

6. A memory device according to claim 2 in use as part of a security system, the USB connector of the memory device in use projecting from one edge of the polygon and occupying a predetermined position relative to two mutually spaced outermost edges of the polygon having a predetermined distance between them, said memory device being located in a read/write unit to read data from and/or to write data to the memory device, said read/write unit having
(a) an entrance slot to receive at least partially the body inserted into said slot with the USB connector leading,
(b) mutually spaced engagement means, having a like predetermined distance between them, within the unit for engagement of the said two mutually spaced outermost edges of the polygon, and
(c) a USB interface slot socket to receive and be couplingly connected to the projecting USB connector of said inserted body, said socket occupying a position relative to said mutually spaced engagement means in correspondence with said predetermined position of the USB connector.

7. A memory device according to claim 3 in use as part of a security system, the USB connector of the memory device in use projecting from one edge of the polygon and occupying a predetermined position relative to two mutually spaced outermost edges of the polygon having a predetermined distance between them, said memory device being located in a read/write unit to read data from and/or to write data to the memory device, said read/write unit having
(a) an entrance slot to receive at least partially the body inserted into said slot with the USB connector leading,
(b) mutually spaced engagement means, having a like predetermined distance between them, within the unit for engagement of the said two mutually spaced outermost edges of the polygon, and
(c) a USB interface slot socket to receive and be couplingly connected to the projecting USB connector of said inserted body, said socket occupying a position relative to said mutually spaced engagement means in correspondence with said predetermined position of the USB connector.

8. A memory device according to claim 4 in use as part of a security system, the USB connector of the memory device in use projecting from one edge of the polygon and occupying a predetermined position relative to two mutually spaced outermost edges of the polygon having a predetermined distance between them, said memory device being located in a read/write unit to read data from and/or to write data to the memory device, said read/write unit having
(a) an entrance slot to receive at least partially the body inserted into said slot with the USB connector leading,
(b) mutually spaced engagement means, having a like predetermined distance between them, within the unit for engagement of the said two mutually spaced outermost edges of the polygon, and
(c) a USB interface slot socket to receive and be couplingly connected to the projecting USB connector of said inserted body, said socket occupying a position relative to said mutually spaced engagement means in correspondence with said predetermined position of the USB connector.

9. A memory device according to claim 5, wherein the mutually spaced engagement means of the read/write unit are provided by rollers, slides or other guidance members to guide the body of the memory device along the path of its insertion into the read/write unit.

10. A memory device according to claim 5, wherein the mutually spaced engagement means of the read/write unit are provided by the opposed, narrow, side walls of an open-mouthed, box-like receptacle having its mouth defined by said entrance slot, a base wall of said receptacle serving to mount said USB interface slot socket and to provide an end stop for said one edge of the polygon when the memory device's body is inserted.

11. A memory device according to claim 5 wherein the read/write unit is for use by a system administrator and the memory device therefor is the administrator memory device, and said security system comprises another, like, read/write unit, the two units being in use connected to one another with said other read/write unit being for use by an end user or data recipient and to receive another, like, memory device personal to that end user.

12. A memory device according to claim 9 wherein the read/write unit is for use by a system administrator and the memory device therefor is the administrator memory device, and said security system comprises another, like, read/write unit, the two units being in use connected to one another with said other read/write unit being for use by an end user or data recipient and to receive another, like, memory device personal to that end user.

13. A memory device according to claim 10 wherein the read/write unit is for use by a system administrator and the memory device therefor is the administrator memory device, and said security system comprises another, like, read/write unit, the two units being in use connected to one another with said other read/write unit being for use by an end user or data recipient and to receive another, like, memory device personal to that end user.

14. A memory device according to claim 11 wherein the security system is programmed to permit selected data from an updatable memory store to be transferred to the personal memory device under the control of the administrator's read/write unit.

15. A memory device according to claim 14 wherein the administrator's read/write unit is programmed to manipulate and/or translate the selected data it receives into a uniform format and transfer it in that format
(a) to the end user read/write unit so as to be written to the personal memory device therein, and
(b) to the administrator read/write unit so as to be written to the administrator's memory device therein to be added to previously written and transferred selected data pertaining to previous end users of the system.

16. A memory device according to claim 14 wherein, before transferring said selected data which is preferably specific to the end user, the said program controlling the administrator read/write unit generates a master code that is transferred to the end user read/write unit so as to be written to the personal memory device therein in combination with a personal code generated by the end user read/write unit.

17. A memory device according to claim 15 wherein, before transferring said selected data which is preferably specific to the end user, the said program controlling the administrator read/write unit generates a master code that is transferred to the end user read/write unit so as to be written to the personal memory device therein in combination with a personal code generated by the end user read/write unit.

18. A plurality of memory devices according to claim 5, said memory devices having different predetermined positions for their respective projecting USB connectors, the said read/write unit including a plurality of USB interface slot sockets occupying different positions relative to the said mutually spaced engagement means, each such socket position corresponding respectively to a different one of predetermined USB connector positions of the plurality of memory devices.

19. A plurality of memory devices according to claim 18 and, wherein each of said plurality of USB interface sockets has its side edges spaced from the line of each of said two mutually spaced engagement means of the read/write unit.

20. A plurality of memory devices according to claim 18 and, wherein one of said plurality of USB interface sockets has a side edge in alignment with one of said two mutually spaced outermost engagement means.
